(19) United States
(12) Patent Application Publication
(10) Pub. No.: US 2010/0116960 A1
(43) Pub. Date: May 13, 2010

(54) ACCESSORY HOLDING DEVICE MOUNTABLE TO HANDLES OF WHEELBARROW

(76) Inventor: Michael Lusk, Naples, FL (US)

Correspondence Address: JAY M. SCHLOFF, 6960 Orchard Lake Road, Suite 315, West Bloomfield, MI, 48322, US

(21) Appl. No.: 12/540,595

(22) Filed: Aug. 13, 2009

Related U.S. Application Data
(60) Provisional application No. 61/114,325, filed on Nov. 13, 2008.

(51) Int. Cl. A47F 7/00; B62B 7/02

(52) U.S. Cl. 248/314; 280/47.31

(57) ABSTRACT

An accessory holding device for a wheelbarrow includes a body member and a strap member. The body member has a flat surface with a periphery. The body member includes a plurality of compartments configured on the flat surface for receiving accessories. Further, the strap member is disposed on a portion of the periphery of the flat surface. The strap member includes a hook and loop fastener disposed on each of a first end portion and a second end portion of the strap member. The first end portion and the second end portion of the strap member extend outwardly from the periphery. Furthermore, the hook and loop fastener disposed on each of the first end portion and the second end portion is capable of removably mounting the body member to a pair of handles extending in a spaced apart relation with each other from the wheelbarrow.

### CROSS REFERENCE TO RELATED APPLICATIONS

The present disclosure claims priority under 35 United States Code, Section 119 on the U.S. Provisional Patent Application No. 61/114,325 filed on Nov. 13, 2008, the disclosure of which is incorporated by reference.

### FIELD OF THE DISCLOSURE

The present disclosure relates to wheelbarrows, and, more particularly, to an accessory holding device mountable to handles of a wheelbarrow.

### BACKGROUND OF THE DISCLOSURE

Generally, wheelbarrows are used as an efficient and economical means for conveying various materials from one place to another during commercial construction, gardening activities, and the like. Because of the nature of tasks involved in the commercial construction and in the gardening activities, various accessories such as shovels, clippers and other equipment are also needed by an individual for performing the tasks while using and/or maneuvering a wheelbarrow. Handling various accessories as well as maneuvering the wheelbarrow at a same time may be a cumbersome task for an individual, which may lead to the individual's frustration.

Various methods have been utilized for transporting of such accessories from one place to another along with the wheelbarrow in order to reduce the individual's frustration level. One such method includes placing of the accessories in containers of the wheelbarrow along with the bulk material. Another such method includes hanging of the accessories on the wheelbarrow's handles. As is readily apparent, such methods are unsatisfactory, since such accessories are prone to damage due to jostling in the container or falling off of the wheelbarrow and the wheelbarrow's handles.

Accordingly, there exists a need to preclude damage to the accessories due to jostling in the container or falling off from the wheelbarrow or from the wheelbarrow's handles. Further, there exists a need to carry the accessories without interference with the normal use of the wheelbarrow. Furthermore, there exists a need to decrease the individual's frustration level due to handling various accessories as well as maneuvering the wheelbarrow at a same time.

### SUMMARY OF THE DISCLOSURE

In view of the foregoing disadvantages inherent in the prior art, the general purpose of the present disclosure is to provide an accessory holding device for a wheelbarrow to include all the advantages of the prior art, and to overcome the drawbacks inherent therein.

Accordingly, an object of the present disclosure is to preclude damage to accessories due to jostling in a container of a wheelbarrow and/or falling off the accessories from the wheelbarrow or from the wheelbarrow's handles.

Another object of the present disclosure is to carry the accessories without interference with a normal use of the wheelbarrow.

Another object of the present disclosure is to decrease an individual's frustration level due to handling various accessories as well as maneuvering the wheelbarrow at the same time.

In light of the above objects, in one aspect of the present disclosure, an accessory holding device for a wheelbarrow is provided. The accessory holding device comprises a body member and a strap member. The body member has a flat surface with a periphery. The body member comprises a plurality of compartments configured on the flat surface for receiving accessories therein. Further, the strap member is disposed on a portion of the periphery of the flat surface. The strap member comprises a hook and loop fastener disposed on each of a first end portion and a second end portion opposite to the first end portion of the strap member. The first end portion and the second end portion of the strap member extend outwardly from the periphery. The hook and loop fastener disposed on each of the first end portion and the second end portion is capable of removably mounting the body member to a pair of handles extending in a spaced apart relation with each other from the wheelbarrow.

The accessory holding device, as disclosed, is capable of being removably mounted to the pair of handles of the wheelbarrow. Specifically, the hook and loop fastener disposed on each of the first end portion and the second end portion opposite to the first end portion of the strap member is capable of mounting the accessory holding device to the wheelbarrow, thereby keeping an individual's hands free for maneuvering the wheelbarrow. Further, the accessory holding device enables the individuals to carry the accessories by storing them in the plurality of compartments configured on the flat surface of the body member of the accessory holding device, thereby facilitating the individuals in carrying the accessories without interference with the normal use of the wheelbarrow. Moreover, the accessory holding device facilitates the individuals in storing the accessories in the plurality of compartments for carrying the accessories along with the wheelbarrow, thereby precluding damage to the accessories due to jostling in the container of the wheelbarrow and/or falling off the accessories from the wheelbarrow or the wheelbarrow's handles.

This together with other aspects of the present disclosure, along with the various features of novelty that characterize the present disclosure, is pointed out with particularity in the claims annexed hereto and form a part of this present disclosure. For a better understanding of the present disclosure, its operating advantages, and the specific objects attained by its uses, reference should be made to the accompanying drawing and descriptive matter in which there are illustrated exemplary embodiments of the present disclosure.

### BRIEF DESCRIPTION OF THE DRAWINGS

The advantages and features of the present disclosure will become better understood with reference to the following detailed description and claims taken in conjunction with the accompanying drawing, in which:

FIG. 1A illustrates a perspective view of an accessory holding device, in accordance with an exemplary embodiment of the present disclosure;

FIG. 1B illustrates a perspective view of an accessory holding device with accessories, in accordance with an exemplary embodiment of the present disclosure;

FIG. 2A illustrates an accessory holding device removably mounted to a wheelbarrow, in accordance with an exemplary embodiment of the present disclosure;

FIG. 2B illustrates a side view of the wheelbarrow of FIG. 2A depicting various positions of an accessory holding device, when the wheelbarrow is maneuvered on different surfaces, in accordance with an exemplary embodiment of the present disclosure; and

FIG. 2C illustrates a side view of the wheelbarrow of FIG. 2A depicting a substantially vertical position of an accessory holding device, when the wheelbarrow is dumped, in accordance with an exemplary embodiment of the present disclosure.

Like reference numerals refer to like parts throughout the description of several views of the drawings.

### DETAILED DESCRIPTION OF THE DISCLOSURE

The exemplary embodiments described herein detail for illustrative purposes are subject to many variations in composition, structure, and design. It should be emphasized, however, that the present disclosure is not limited to an accessory holding device for a wheelbarrow as shown and described. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The term “first,” “second,” and the like, herein do not denote any order, elevation or importance, but rather are used to distinguish placement of one element over another. Further, the terms “a” and “an” herein do not denote a limitation of quantity, but rather denote the presence of at least one of the referenced item.

The present disclosure provides an accessory holding device for a wheelbarrow. The accessory holding device is capable of being removably mounted to a pair of handles of the wheelbarrow for enabling an individual to conveniently carry accessories such as shovels, clippers, and various other gardening and construction tools without interference with a normal use of the wheelbarrow.

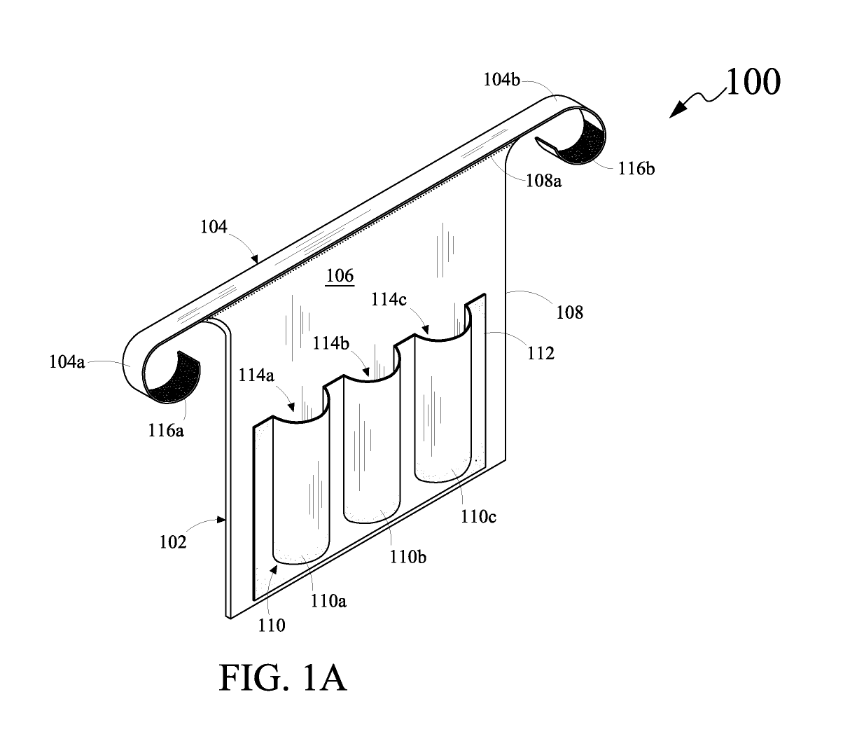

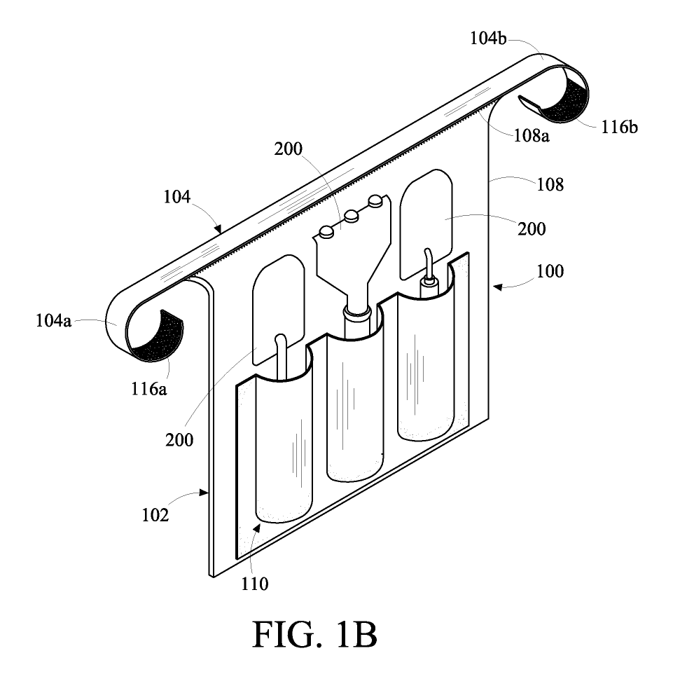

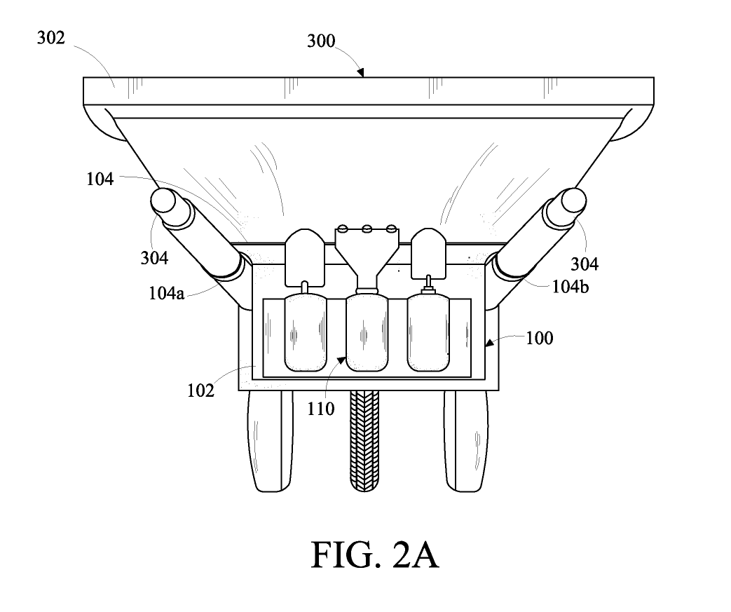

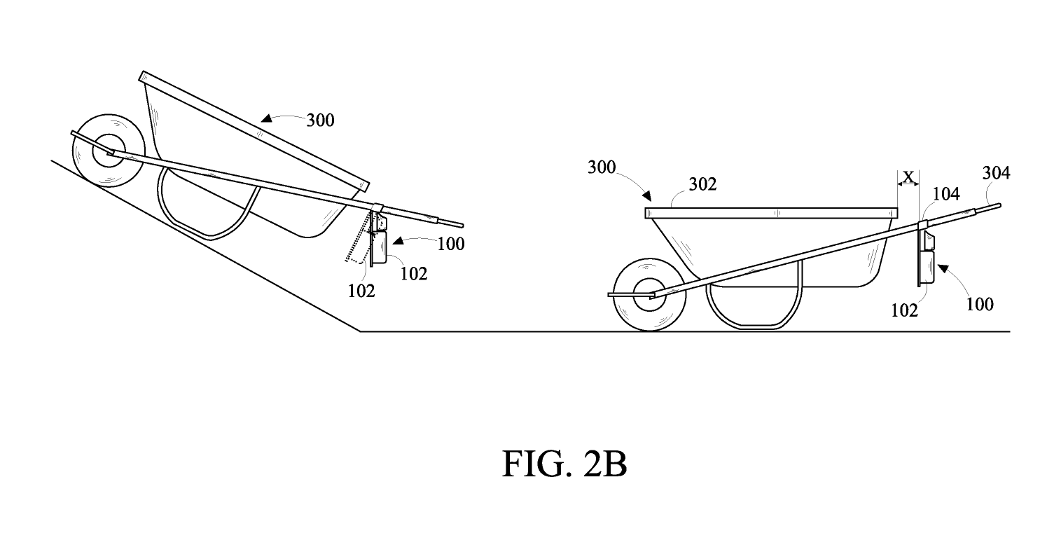

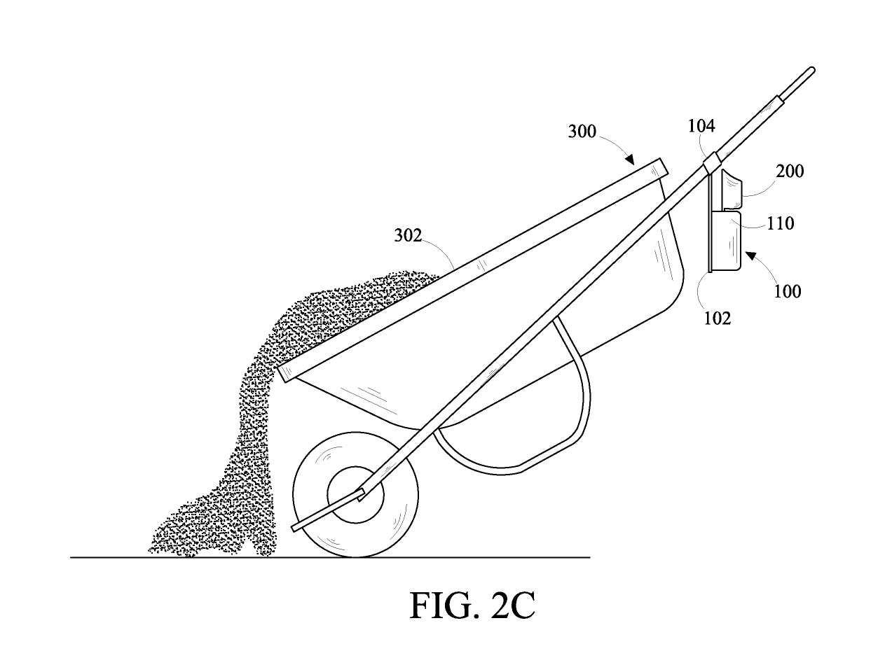

Referring now to FIGS. 1A and 1B, an accessory holding device 100 is illustrated, in accordance with an embodiment of the present disclosure. Specifically, FIG. 1A illustrates a perspective view of the accessory holding device 100, and FIG. 1B illustrates the accessory holding device 100 with accessories 200, such as shovels, clippers, and various other gardening and construction tools. The accessory holding device 100 includes a body member 102, and a strap member 104 attached to the body member 102 for enabling the body member 102 to move in a swingable manner, when the accessory holding device 100 is removably mounted to a pair of handles of a container, as shown in FIGS. 2A to 2C. More specifically, when the body member 102 is mounted to the pair of handles of the wheelbarrow via the strap member 104, the body member 102 may swing freely to remain in substantially a vertical position with respect to a surface on which the wheelbarrow is maneuvered, independent of a nature of the surface, i.e. a slope or a plain nature of the surface. The accessory holding device 100 enables an individual to conveniently store the accessories 200 without interference with a normal use of the wheelbarrow. Utility of the accessory holding device 100 with the wheelbarrow will be described in conjunction with FIGS. 2A to 2C.

The body member 102 has a flat surface 106 and a periphery 108. The body member 102 includes a plurality of compartments, such as compartments 110a, 110b and 110c. As shown in FIGS. 1A and 1B, the body member 102 includes three compartments, such as the compartments 110a, 110b and 110c, however without departing from the scope of the present disclosure, the body member 102 may include more or less than the three compartments. Hereinafter, the compartments 110a, 110b and 110c will be collectively referred to as ‘compartments 110’. The compartments 110 are configured on the flat surface 106 of the body member 102. In an embodiment of the present disclosure, the compartments 110 may be configured on the flat surface 106 of the body member 102 by attaching a flap 112 of a canvas material onto the flat surface 106 of the body member 102 by methods including, but not limiting, to stitching, gluing and the like. The compartments 110 configured on the flat surface 106 of the body member 102 are like pouches, each having an opening such as openings 114a, 114b and 114c for receiving the accessories 200 therefrom in the pouch like compartments, such as the compartments 110. Similar to the material of the flap 112, the body member 102 is also composed of a canvas material. However without departing from the scope of the present disclosure, the body member 102 and the flap 112 by which the compartments 110 are configured on the flat surface 106 may be composed of various other types of materials known in the art. Further, the body member 102 of the accessory holding device 100 may be composed of different colors so as to accommodate various individual preferences. Furthermore, the body member 102 is coupled to the strap member 104.

Specifically, the strap member 104 is disposed on a portion 108a of the periphery 108 of the flat surface 106 of the body member 102. The strap member 104 has a first end portion 104a and a second end portion 104b opposite to the first end portion 104a. The strap member 104 is disposed on the portion 108a of the periphery 108 in a manner such that the first end portion 104a and the second end portion 104b extend outwardly from the from the portion 108a of the periphery 108. The first end portion 104a and the second end portion 104b of the strap member 104 are configured to include a curved shape so that the body member 102 may be hanged on the pair of handles of the wheelbarrow. However, it will be evident to a person skilled in the art that the first end portion 104a and the second end portion 104b may be configured to include any other bent shape for hanging the body member 102 on the pair of handles of the wheelbarrow using such bent shape of the first end portion 104a and the second end portion 104b. Furthermore, the body member 102 may be removably mounted to the pair of handles of the wheelbarrow upon hanging the body member 102 on the pair of handles.

Specifically as shown in FIGS. 1A and 1B, the strap member 104 includes a hook and loop fastener, such as a hook and loop fastener 116a and a hook and loop fastener 116b. The hook and loop fastener 116a and the hook and loop fastener 116b are, respectively disposed on the first end portion 104a and the second end portion 104b of the strap member 104. Hereinafter, the hook and loop fastener 116a and the hook and loop fastener 116b will be also collectively referred to as ‘hook and loop fasteners 116.’ The hook and loop fasteners 116 are capable of removably mounting the body member 102 to the pair of handles of the wheelbarrow. In one embodiment of the present disclosure, the hook and loop fasteners 116 may be a Velcro™. However, it will be evident to a person skilled in the art to use any other type of hook and loop fastener for removably mounting the body member 102 to the pair of handles of the wheelbarrow. The accessory holding device 100 mounted to the wheelbarrow, and utility of the accessory holding device 100, will be now described herein in conjunction with FIGS. 2A to 2C.

Referring to FIGS. 2A to 2C, the accessory holding device 100 being utilized with respect to a wheelbarrow 300 is illustrated in accordance with an embodiment of the present disclosure. Specifically, FIG. 2A illustrates a back view of the accessory holding device 100 removably mounted to the wheelbarrow 300, FIG. 2B illustrates a side view of the wheelbarrow 300 of FIG. 2A depicting various positions of the accessory holding device 100, when the wheelbarrow 300 is maneuvered on different surfaces, and FIG. 2C illustrates a side view of the wheelbarrow 300 of FIG. 2A depicting a substantially vertical position of the accessory holding device 100, when the wheelbarrow 300 is dumped. Herein, references of FIGS. 1A and 1B will be taken to describe the accessory holding device 100 being utilized with respect to the wheelbarrow 300.

As shown in FIGS. 2A to 2C, the wheelbarrow 300 to which the accessory holding device 100 is removably mounted includes a container 302 and a pair of handles 304. The pair of handles 304 extends from the container 302. The pair of handles 304 extends in a spaced apart relation with each other from the container 302 of the wheelbarrow 300. Further as shown in FIGS. 2A to 2C, the accessory holding device 100 is being removably mounted the pair of handles 304 of the wheelbarrow 300. Specifically, the body member 102 is removably mounted to the pair of handles 304 by the hook and loop fastener 116a and the hook and loop fastener 116b disposed, respectively on the first end portion 104a and the second end portion 104b of the strap member 104. Further, the body member 102 is removably mounted to the pair of handles 304 in a swingable manner. Specifically, the strap member 104 is composed of a flexible material that in turn enables mounting of the body member 102 to the pair of handles 304 in the swingable manner. Furthermore as shown in FIG. 2B, the body member 102 is removably mounted on the pair of handles 304 at a pre-determined distance ‘X’ from the container 302 of the wheelbarrow 300. The pre-determined distance ‘X’ is such that the accessory holding device 100 may not touch the container 302, when the accessory holding device 100 is removably mounted to the wheelbarrow 300.

Moreover as shown in FIG. 2B, when the body member 102 is mounted to the pair of handles 304 of the wheelbarrow 300 via the strap member 104 at the pre-determined distance ‘X’ from the container 302, the body member 102 may swing freely for being remained in a substantially vertical position with respect to a surface on which the wheelbarrow 300 is maneuvered, independent of a nature of the surface, i.e. a sloped or a unsloped nature of the surface. More specifically as shown in FIG. 2B, when the wheelbarrow 300 is maneuvered on the unsloped nature of the surface, the body member 102 is at the substantially vertical position with respect to the surface. Further, when the wheelbarrow 300 is maneuvered on the sloped nature of the surface, the body member 102 may swing freely from a slanted position (shown as the dotted body member 102) to a substantially vertical position (shown as the normal lined body member 102) with respect to the surface, due to the flexible nature of the strap member 104. Such swinging of the body member 102 from the slanted position to the substantially vertical position with respect to the surface enables the accessory holding device 100 to remain in the substantially vertical position with respect to the surface (the sloped or the unsloped nature of the surface) on which the wheelbarrow is maneuvered. The substantially vertical position of the accessory holding device 100 with respect to the surface prevents the accessories 200 stored in the compartments 110 from falling out of the compartments 110.

Furthermore, such swinging of the body member 102 also prevents a possibility of the accessories 200 from falling out from the compartments 110, when the wheelbarrow 300 is in a dumping position. More specifically as shown in FIG. 2C, when the wheelbarrow 300 is tilted forward to dump waste materials stored in the container 302 thereof, the body member 102 of the accessory holding device 100 may swing freely to attain the substantially vertical position thereby preventing the accessories 200 stored in the compartments 110 from falling out.

The present disclosure provides an accessory holding device, such as the accessory holding device 100, which offers the following advantages. The accessory holding device is capable of being removably mounted to a pair of handles of a wheelbarrow. The accessory holding device is capable of being mounted to the pair of handles of the wheelbarrow, thereby keeping an individual's hands free for maneuvering the wheelbarrow. Further, the accessory holding device enables the individuals to carry accessories, such as the accessories 200, while storing the accessories in compartments, such as the compartments 110, configured thereon for facilitating the individuals to carry the accessories without interference with the normal use of the wheelbarrow. Moreover, the accessory holding device enables the individuals to store the accessories in the compartments for carrying the accessories along with the wheelbarrow, which precludes damage of the accessories due to jostling in a container of the wheelbarrow and/or falling off the accessories from the wheelbarrow or from the pair of handles of the wheelbarrow.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. An accessory holding device for a wheelbarrow, the accessory holding device comprising:
a body member having a flat surface with a periphery, the body member comprising a plurality of compartments configured on the flat surface, wherein the plurality of compartments is capable of receiving accessories therein; and
a strap member disposed on a portion of the periphery of the flat surface, the strap member comprising a hook and loop fastener disposed on each of a first end portion and a second end portion opposite to the first end portion of the strap member, wherein each of the first end portion and the second end portion of the strap member extends outwardly from the periphery,
wherein the hook and loop fastener disposed on each of the first end portion and the second end portion is capable of removably mounting the body member to a pair of handles extending in a spaced apart relation with each other from the wheelbarrow.

2. The accessory holding device of claim 1, wherein the body member is removably mounted on the pair of handles in a swingable manner.

3. The accessory holding device of claim 1, wherein the body member is removably mounted on the pair of handles at a predetermined distance from a container of the wheelbarrow.

4. The accessory holding device of claim 1, wherein each of the first end portion and the second end portion is configured to comprise a curved shape.

5. The accessory holding device of claim 1, wherein the body member is composed of a canvas material.
